(19) United States
(12) Patent Application Publication
(10) Pub. No.: US 2014/0218158 A1
(43) Pub. Date: Aug. 7, 2014

(54) REACTOR

(71) Applicant: Shingo MIYAMOTO, Toyota-shi (JP)

(72) Inventor: Shingo MIYAMOTO, Toyota-shi (JP)

(73) Assignee: TOYOTA JIDOSHA KABUSHIKI KAISHA, Toyota-shi (JP)

(21) Appl. No.: 14/171,467

(22) Filed: Feb. 3, 2014

(30) Foreign Application Priority Data
Feb. 4, 2013 (JP) 2013-019401

(51) Int. Cl. H01F 27/28

(52) U.S. Cl. CPC H01F 27/2895
USPC 336/198

(57) ABSTRACT

A reactor includes a ring-shaped core, a bobbin, two coils. The bobbin includes a first part that includes two first tubular sections and a first flange and includes a second part that includes two second tubular sections and a second flange. Each of base ends of the first tubular sections is coupled to the first flange and each of base ends of the two second tubular sections is coupled to the second flange. Each of the first tubular sections includes a tongue section extending from a distal end of the first tubular section and fitting into a distal end of the second tubular section. Each of the two coils is wound around a corresponding one of the first tubular sections and a corresponding one of the second tubular sections of the bobbin.

### BACKGROUND OF THE INVENTION

1. Field of the Invention

The present invention relates to a reactor. A reactor is a passive element using a coil and also referred to as “inductor”.

2. Description of Related Art

The reactor may be used in a circuit such as a voltage converter in a motor drive system of electric vehicles including hybrid vehicles. The reactor includes a coil, a bobbin around which the coil is wound, and a core inserted in the bobbin. Japanese Patent Application Publication No. 2008-078219 (JP 2008-078219 A) and Japanese Patent Application Publication No. 2006-351662 (JP 2006-351662 A) disclose typical reactors that are used for electric vehicles. A common form of those reactors is as follows. The reactor is configured with a ring-shaped core that has sections extending in parallel with each other, two bobbins that surround the parallel sections of the core, and coils that are wound around respective tubular sections of the bobbins. Here, the ring-shaped core includes a pair of U-shaped cores that is disposed such that end surfaces face each other and I-shaped cores that are disposed between the end surfaces of the pair of U-shaped cores that face each other and housed in the tubular sections of the bobbin. Spacer plates are disposed between the end surfaces of the U-shaped cores and the I-shaped cores. The core is formed of a metal soft magnetic powder, a magnetic steel plate, ferrite, or the like. The bobbin is often made of a resin.

### SUMMARY OF THE INVENTION

The bobbin preferably includes first tubular sections and second tubular sections which extend in a coil axial direction in view of assembly efficiency. On the other hand, components are required to be precisely assembled in order to enhance performance of the reactor. The present invention provides a reactor that adopts a bobbin including a first part and a second part which are separate from each other in the coil axial direction and components can be precisely assembled.

A reactor in accordance with an aspect of the present invention has a ring-shaped core having sections that extend in parallel to each other. Accordingly, the bobbin includes a first part and a second part. The first part includes two first tubular sections and a first flange. The second part includes two second tubular sections and a second flange. One of the first tubular sections and one of the second tubular sections each covering a corresponding one of the parallel sections of the core. Each of base ends of the first tubular sections is coupled to the first flange. Each of base ends of the second tubular sections is coupled to the second flange. The flanges are sections that cover ends of coils wound around the core. The coil is wound around each of a corresponding one of the first tubular sections and a corresponding one of the second tubular sections of the bobbin. In the reactor in accordance with the aspect of the present invention, the bobbin includes a first part and a second part, and tongue sections that fit on distal ends of the second tubular sections of the second part extend from the distal ends of the first tubular sections of the first part. Recessed sections on which the tongue sections of the first part fit are provided on the inside surfaces of the second tubular sections of the second part. The axial line of the first tubular sections or the axial line of the second tubular sections corresponds to a coil axial line. Further, “tongue section” is a plate section that extends from the distal end of the first tubular section.

In the reactor, the bobbin includes two parts fit together through the tongue sections and the recessed sections. Accordingly, the two parts can precisely be combined.

The ring-shaped core may also be plural parts. Typically, the ring-shaped core may be a pair of U-shaped cores that are disposed such that end surfaces face each other and I-shaped cores that are positioned between the end surfaces of the pair of U-shaped cores and housed in the first tubular sections and the second tubular sections of the bobbin. Spacer plates may be disposed between the end surfaces of the U-shaped cores and the I-shaped cores. The spacer plate is an insulator, which is formed of ceramics, for example. In a case where the ring-shaped core includes the I-shaped cores and the pair of U-shaped cores, projections that define the positions of the I-shaped cores in the coil axial direction (the axial direction of the first tubular sections or the axial direction of the second tubular sections) may be provided on inner peripheries of the first tubular sections and the second tubular sections of the bobbin. Each of the spacer plates may be disposed on an inside surface of the projection. In other words, the projections restrict movement of the I-shaped cores in one direction in the axial direction. The projections on the inside surfaces of the first and second tubular sections precisely define the positions of two components that are the I-shaped core and the spacer plate.

Further, in the reactor in accordance with the aspect of the present invention, protrusions that define the positions of the coils in the radial direction from axes of the first tubular sections and the second tubular sections may extend in the axial direction of the first tubular sections and the second tubular sections on the outside surfaces of the first and second tubular sections of the bobbin.

The bobbin of the reactor in accordance with the aspect of the present invention includes the first part and the second part. Accordingly, combining precision of the parts can be improved, and the shape of the bobbin contributes to highly precise positioning of the cores, the spacer plates, and further the coils.

In the reactor of the aspect of the present invention, at least portions of the coils and at least a portion of the bobbin may be covered by an injection molding resin.

Details of a technique and further improvements of the aspect of the present invention will be described in “DETAILED DESCRIPTION OF EMBODIMENTS” below.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a exploded perspective view of a reactor of an embodiment;

FIG. 2 is a perspective view of the reactor (except a resin cover);

FIG. 3 is a cross-sectional view taken along line in FIG. 2;

FIG. 4 is a cross-sectional view taken along line IV-IV in FIG. 2; and

FIG. 5 is a perspective view of the reactor (including the resin cover).

### DETAILED DESCRIPTION OF EMBODIMENTS

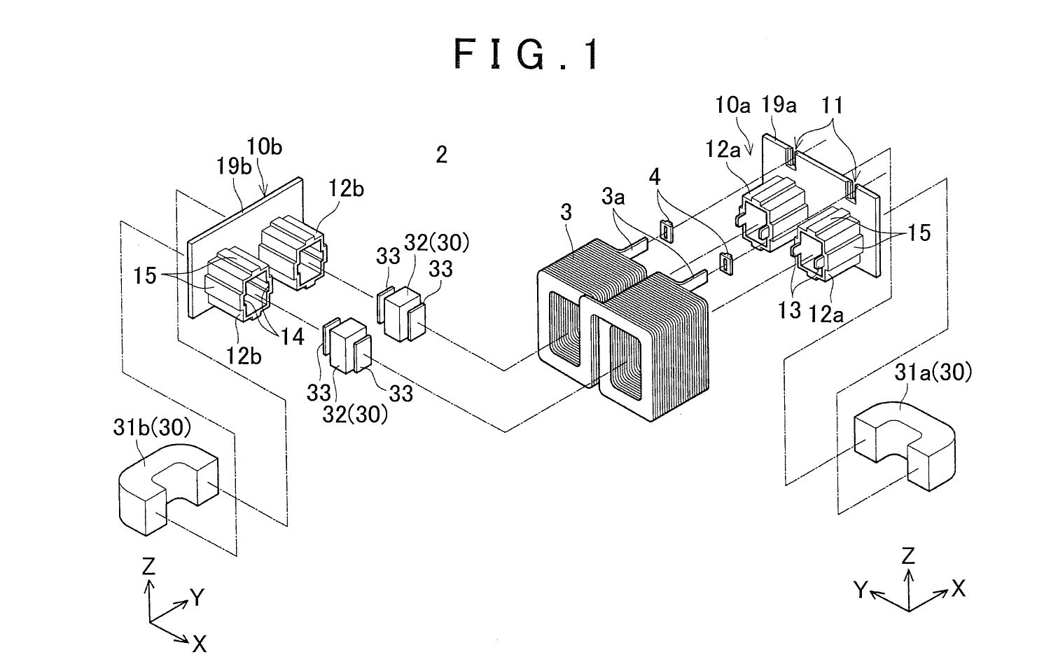

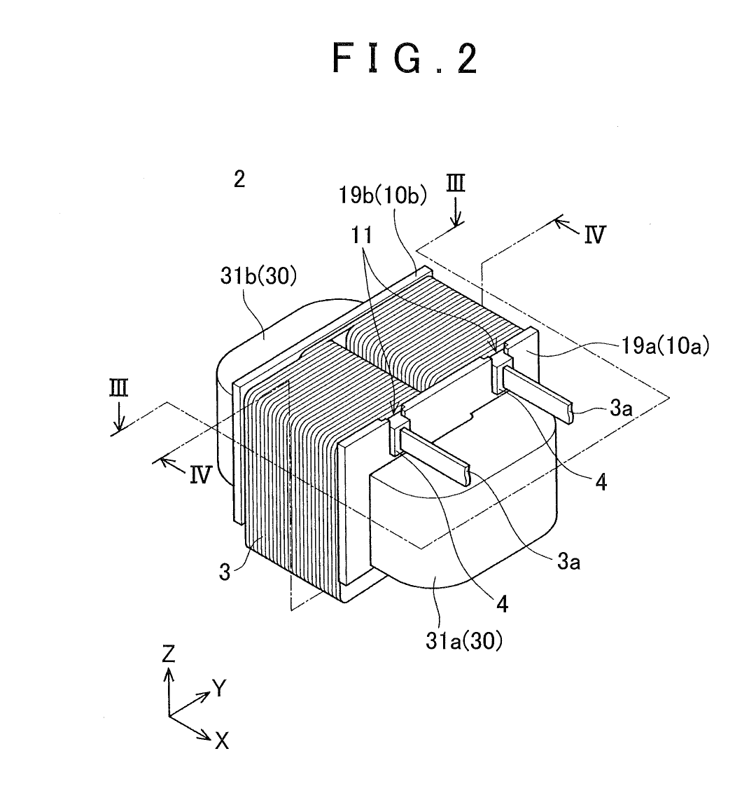

A reactor of an embodiment will be described with reference to drawings. FIG. 1 is an exploded perspective view of a reactor 2 before resin molding, and FIG. 2 is a perspective view of the reactor 2 before the resin molding. For example, the reactor 2 is used for a converter that increases a battery voltage to an appropriate voltage for motor drive in an electric vehicle. Such a reactor 2 has an allowable current value of 100 [A] or higher, is for high current application, and uses a flat wire to be wound around a coil. The flat wire has a rectangular cross section and low electric resistance. The flat wire is wound with its wider surface directed in the coil longitudinal direction in the reactor. In other words, a narrower surface is directed in the coil radial direction. Such winding is referred to as “edgewise winding” or “longitudinal winding”.

A structure of the reactor 2 will be outlined. The reactor 2 includes two coils 3 that are electrically connected in series and physically disposed with axial lines in parallel to each other, a bobbin 10 that is inserted in the coils 3, and a core 30 that passes through the insides of tubes of the bobbin 10.

The ring-shaped core 30 is formed with a pair of U-shaped cores 31a, 31b and I-shaped cores 32. Each of the cores is formed of ferrite particles coated with an insulating material and baked with a resin. The pair of U-shaped cores 31a, 31b is disposed such that end surfaces face each other. The I-shaped cores 32 are disposed between the pair of U-shaped cores 31a, 31b. The two I-shaped cores 32 arranged in parallel constitute parallel sections in the ring-shaped core. Spacer plates 33 are disposed between the end surfaces of the U-shaped cores 31a, 31b and the I-shaped cores 32. The spacer plate 33 is formed of ceramics.

The bobbin 10 includes two parts, such as a first part 10a and a second part 10b. The first part 10a has a structure where base ends of two first tubular sections 12a are coupled to a first flange 19a in parallel with the two coils 3. The second part 10b has a structure where base ends of two second tubular sections 12b are coupled to a second flange 19a in parallel with the two coils 3. The flange 19a defines one end of a coil winding range and the flange 19b defines the other end of the coil winding range. The coil 3 has a shape where the flat wire is wound in a general rectangle, and the first tubular sections 12a and the second tubular sections are also in general rectangular. Two tongue sections 13 extend from distal ends of the first tubular sections 12a of the first part 10a. The tongue sections 13 fit on recessed sections 14 that are provided on the inside surfaces of the second tubular sections 12b at the distal end of each of the second tubular sections 12b of the second part 10b. FIG. 1 shows the front tubular sections of the parallel first tubular sections 12a and the parallel second tubular sections 12b with a reference numeral 13 (the tongue section) and a reference numeral 14 (the recessed section) and does not show reference numerals of the tongue sections and the recessed sections on the deeper side.

The tongue sections 13 extend from two sides facing each other of a rectangular cross section of the first tubular section 12a. When the tongue sections 13 are fit on the recessed sections 14, the first part 10a and the second part 10b are precisely combined together. That is, the tongue sections 13 and the recessed sections 14 precisely position the first part 10a and the second part 10b that constitute the bobbin 10.

In an assembly step of the reactor 2, before the first part 10a and the second part 10b are combined together, the first tubular sections 12a and the second tubular sections 12b are inserted in the coils 3, and the I-shaped cores 32 and the spacer plates 33 are disposed in the first tubular sections 12a and the second tubular sections 12b. When the first part 10a and the second part 10b are combined together with the coils 3 interposed therebetween and the bobbin 10 is thereby assembled, the first flange 19a and the second flange 19b define the coil winding range. In other words, the first flange 19a and the second flange 19b cover the end surfaces of the coils 3 respectively. The pair of U-shaped cores 31a, 31b is respectively inserted in the first tubular sections 12a and the second tubular sections 12b from both sides of the bobbin 10.

Slits 11 through which lead sections 3a of the coils 3 pass are provided in the first flange 19a of the first part 10a. The lead section 3a passes through the slit 11, and a small plate 4 is disposed between the slit 11 and the lead section 3a. The small plate 4 has a hole through which the lead section 3a passes. A step is provided on a periphery of the small plate 4, and this step section engages with a step provided on the slit 11. The small plate 4 is formed with a small diameter section and a large diameter section across the step. The large diameter section faces the coil 3, and the small diameter section is positioned on the opposite side of the coil 3. The hole of the small plate 4 is in a size that allows tight fitting on the lead section 3a, and the small plate 4 seals the periphery of the lead section 3a. The large diameter section of the small plate 4 abuts against a peripheral edge of the slit 11 from the coil side to close the slit. As described below, the coil 3 is molded with a resin between the first flange 19a and the second flange 19b. When the reactor 2 before resin molding shown in FIG. 2 is put into a die and the resin is injected to a space between the first flange 19a and the second flange 19b, the small plate 4 prevents the resin from leaking from a space between the slit 11 and the lead section 3a.

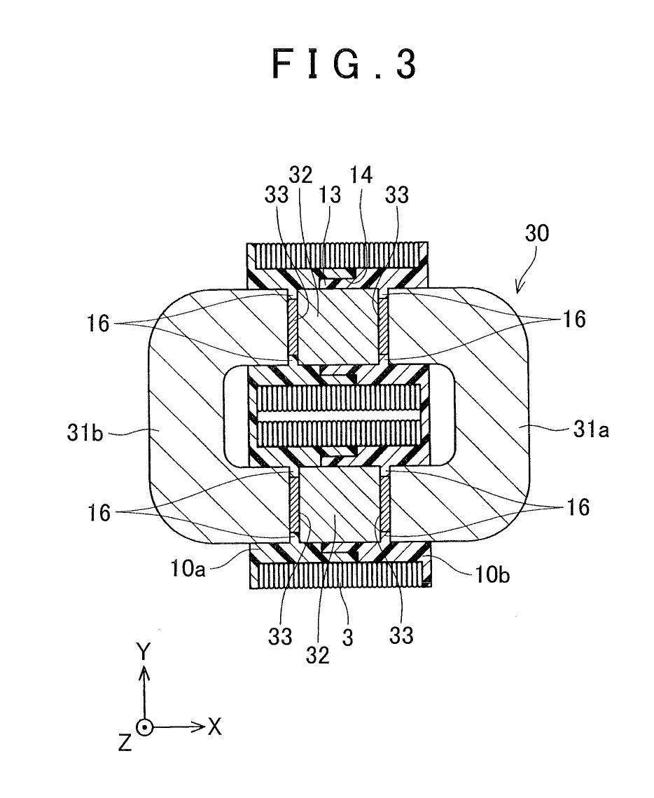

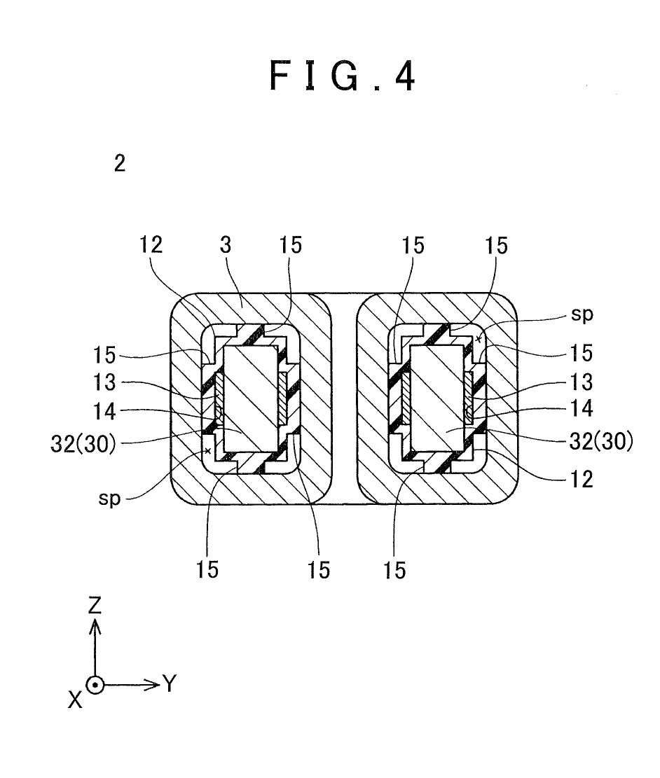

The relationship between the ring-shaped core 30 and the bobbin 10 will be described with reference to FIGS. 3 and 4. FIG. 3 shows a cross section taken along line in FIG. 2, and FIG. 4 shows a cross section taken along line IV-IV in FIG. 2.

Projections 16 are provided on the inside surfaces of the first tubular section 12a and the second tubular sections 12b. The projections 16 are provided around a whole inner periphery of the first tubular section 12a and a whole inner periphery of the second tubular section 12b. The projections 16 define the position of the I-shaped core 32 that is inserted from the distal end side of the first tubular section 12a or from the distal end side of the second tubular section 12b in the axial direction of the first or second tubular section (coil axial direction). The projections 16 define the position of the U-shaped core 31a (U-shaped core 31b) that is inserted from the first flange 19a (second flange 19b) in the axial direction of the first tubular section 12a (second tubular section 12b). As described above, the projections 16 in the first tubular sections 12a and in the second tubular sections 12b respectively define the positions of the I-shaped cores 32 and the U-shaped cores 31a, 31b in the axial direction of the first tubular sections 12a and in the second tubular sections 12b.

The spacer plates 33 are disposed between the end surfaces of the U-shaped cores 31a (U-shaped core 31b) and the I-shaped cores 32. As specifically shown in FIG. 3, the spacer plates 33 are disposed on the inside surfaces of the projections 16 provided around the whole inner periphery of the first tubular section 12a and around the whole inner periphery of the second tubular section 12b.

FIG. 3 shows a state where the tongue sections 13 that extend from the distal ends of the first tubular sections 12a of the first part 10a of the bobbin fit on the recessed sections 14 provided on the inside surfaces at the distal ends of the second tubular sections 12b of the second part 10b. The tongue sections 13 are provided on the two sides facing each other of the rectangular cross section of the single first tubular section 12a. Accordingly, when the tongue sections 13 fit on the recessed sections 14, the relative positions of the first part 10a and the second part 10b are precisely defined.

As shown in FIG. 4, each of the first tubular section 12a and the second tubular sections has a protrusion 15 on each side of an outer periphery of the rectangular cross section. The protrusion 15 extends along the axial direction of the tubular section (see FIG. 1). Further, as specifically shown in FIG. 4, the protrusion 15 is provided on each of the four sides of the outer periphery of the first tubular section 12a and the second tubular sections 12b, and a vertex surface of the protrusion 15 contacts an inner surface of the coil 3. The protrusions 15 define the position of the coil in the radial direction from axes of the first tubular sections 12a and the second tubular sections 12b (the orthogonal direction to the coil axial line). A space denoted by a reference symbol SP in FIG. 4 is filled with the resin when a resin mold 40a (described below) that covers the coils 3 is formed by injection molding.

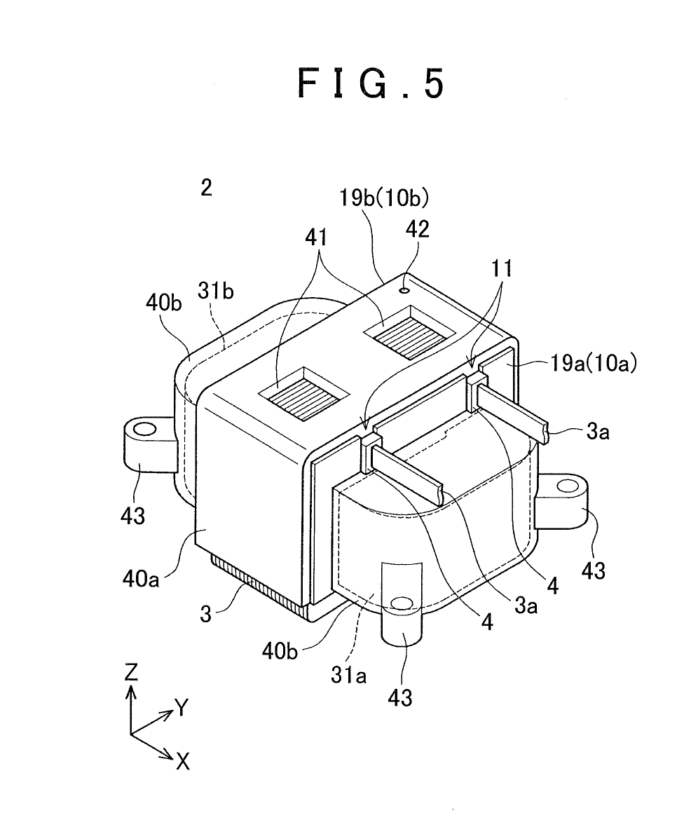

FIG. 5 is a perspective view of the reactor 2 after the resin molding, that is, the completed reactor. The coils 3 are molded with the resin between the first flange 19a and the second flange 19b. The reference symbol 40a denotes the resin mold that covers the coils 3. However, the resin mold 40a has a window in its upper section, through which the coils 3 are partially exposed. Further, lower sides of the coils 3 are exposed through the resin mold 40a. The reference numeral 42 denotes a gate mark. The gate mark corresponds to a resin injection hole provided in a cavity surface of the die when the reactor before the resin molding is put in the die.

The resin mold 40a covers approximately the half thickness of the first flange 19a on the coil side. As described above, the slits 11 for pulling out the lead sections that are formed in the first flange 19a are sealed by the small plates 4, and the resin is thereby prevented from leaking from the space between the slits 11 and the lead sections 3a.

In the reactor 2, the U-shaped cores 31a, 31b are also covered with the resin on the outside surface (the opposite side of the coils 3) of the first flange 19a (second flange 19b). A reference symbol 40b denotes a resin mold that covers the core. The resin mold 40b has fixing ribs 43 for fixing the reactor 2 to a housing. The resin mold 40b is fabricated by the injection molding.

As described above, in the reactor 2, the bobbin 10 includes the first part 10a and the second part 10b. The tongue sections 13 extend from the distal ends of the first tubular sections 12a of the first part 10a and fit on the recessed sections 14 on the inside surfaces of the distal ends of the second tubular sections 12b of the second part 10b. Accordingly, the first part 10a and the second part 10b are precisely positioned. Further, the projections 16 are provided around the whole inner periphery on the inside surface of the first tubular section 12a and around the whole inner periphery on the inside surface of the second tubular section 12b, and the projections 16 define the positions of the I-shaped cores 32 and the U-shaped cores 31a, 31b in the axial direction of the tubular section. In addition, the protrusions 15 that extend along the axial direction of the tubular section are provided on the outside surfaces of the first tubular sections 12a and second tubular sections 12b, and the protrusions 15 define the positions of the coils 3 in the radial direction from axes of the first tubular sections 12a and the second tubular sections 12b. As described above, the bobbin 10 of the reactor 2 is split into the two components (10a, 10b) that can precisely be combined together and includes the projections 16 and the protrusions 15 that precisely define the positions of the other components (U-shaped cores, I-shaped cores, coils).

Points to be noted about the technique described in the embodiment will be described. In the reactor 2 of the embodiment, the tongue sections 13 extend from the two sides facing each other of the rectangular cross section of the first tubular section 12a. The tongue sections 13 may extend from three sides or four sides of the rectangular cross section of the first tubular section 12a. Further, the cross section of the first tubular section 12a or the second tubular sections 12b is preferably rectangular but may be elliptical or circular. The bobbin 10 of the reactor 2 of the embodiment includes the two parts (first part 10a, second part 10b). However, the number of the parts of the bobbin may be three or more. For example, the first flange 19a (second flange 19b) may be splittable from the first tubular sections 12a (second tubular sections 12b).

While the exemplary embodiments have been described, it is to be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less, or only a single element, are also within the spirit and scope of the invention.

What is claimed is:

1. A reactor comprising:
a ring-shaped core including sections that extend in parallel to each other;
a bobbin including a first part and a second part, the first part including two first tubular sections and a first flange, the second part including two second tubular sections and a second flange, one of the first tubular sections and one of the second tubular sections each covering a corresponding one of the parallel sections of the ring-shaped core, each of base ends of the two first tubular sections being coupled to the first flange, each of base ends of the two second tubular sections being coupled to the second flange, and each of the first tubular sections including a tongue section extending from a distal end of the first tubular section and fitting into a distal end of the second tubular section; and
two coils, each wound around a corresponding one of the first tubular sections and a corresponding one of the second tubular sections of the bobbin.

2. The reactor according to claim 1, further comprising spacer plates,
wherein:
the ring-shaped core includes a pair of U-shaped cores and I-shaped cores; the pair of U-shaped cores are disposed with end surfaces facing each other; the I-shaped cores are positioned between the end surfaces of the pair of U-shaped cores and housed in the first tubular sections and the second tubular sections of the bobbin;
the bobbin includes projections for positioning the I-shaped cores; the projections are provided on inner peripheries of the first tubular sections and the second tubular sections of the bobbin; and each of the spacer plates is disposed on an inside surface of the projection in the corresponding one of the first tubular sections and the second tubular sections.

3. The reactor according to claim 1,
wherein the bobbin includes protrusions on outside surfaces of the first tubular sections and the second tubular sections, the protrusions define positions of the coils in a radial direction from axes of the first tubular sections and the second tubular sections, and the protrusions extend in an axial direction of the first tubular sections and the second tubular sections.

4. The reactor according to claim 1,
wherein at least portions of the coils and at least a portion of the bobbin are covered by an injection molding resin.
